(19) United States
(12) Patent Application Publication
(10) Pub. No.: US 2016/0309680 A1
(43) Pub. Date: Oct. 27, 2016

(54) Backyard wildlife feeder

(71) Applicant: Walter Blohm, Florence, OR (US)

(72) Inventor: Walter Blohm, Florence, OR (US)

(21) Appl. No.: 14/545,299

(22) Filed: Apr. 21, 2015

(51) Int. Cl. A01K 5/01; A01K 39/02; A01K 39/014; A01K 7/00

(52) U.S. Cl. CPC A01K 5/01; A01K 7/00; A01K 39/0206; A01K 39/014; A01K 39/02

(57) ABSTRACT

A backyard wildlife feeder with a base member, a central vertical post, a plurality of feeding trays, a plurality of canopy members, a water retaining tray, and plurality of leaf shaped photovoltaic panels. The vertical post has a plurality of plug together sections, the lowest of which attaches to the base. The feeding trays are circular and include a central aperture to allow the vertical post to penetrate through from one tray to the next. The feeding trays are each capped by a canopy member which protects food stored in the trays. One the feeding trays include small orifices to accommodate the feeding of humming birds. One tray includes a hive type assembly for the nesting of bees. The top tray is capable of retaining water and acting as a bird bath. A ladder extends from the base to the lowest the feeding tray which can contain squirrel food.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of animal feeding devices and more specifically to a backyard wildlife feeder.

Bird feeders of various shapes and sizes can be found in many back yards throughout the world. They provide a way for home owners to watch birds at close range as well as a way to provide valuable nourishment. Other species may also be found in back yards such as squirrels, rabbits, bees and butterflies. Some people derive pleasure from feeding these animals also.

Bird feeders have been designed and marketed which include valuable features such as anti spill features and squirrel resistant features. In addition, individual birdbaths and other habitats such as bee houses have been designed and marketed.

However, there is a deficiency in the prior technology in that none of the existing designs provides a way to accommodate a variety of animal types within the same feeding station. Additionally, none of the prior designs is modular and allows the user to expand and customize the feeder as they see fit.

### BRIEF SUMMARY OF THE INVENTION

The primary object of the invention is to provide a backyard wildlife feeder that provides a feeding station for a variety of backyard animals including birds, squires, bees, bats and butterflies.

Another object of the invention is to provide a backyard wildlife feeder that includes vertically stackable feeding stations that can be added or subtracted as needed.

Another object of the invention is to provide a backyard wildlife feeder that includes a leaf shaped photovoltaic electric generating system for powering a water pump and or lights.

A further object of the invention is to provide a backyard wildlife feeder that includes a bee housing for nesting bees.

Yet another object of the invention is to provide a backyard wildlife feeder that includes a bird bath.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed a backyard wildlife feeder comprising: a base member, a central vertical post, a plurality of feeding trays, a plurality of canopy members, a water retaining tray, a plurality of leaf shaped photovoltaic panels, a water pump, a ladder, said vertical post having a plurality of plug together sections, said vertical post attached to said base member, said feeding trays being circular and including a central aperture to allow said vertical post to penetrate through from one tray to the next, said feeding trays each capped by said canopy member which protects food stored in said trays, one said feeding tray including small orifices to accommodate the feeding of humming birds, one said feeding tray including a hive type assembly for the nesting of bees, the top most tray capable of retaining water and acting as a bird bath, said water tray and capable of reticulating said water via said water pump from a sprinkler assembly located directly above said water tray, and said ladder extending from said base member to the lowest said feeding tray which can contain squirrel food and where said squirrels can climb said ladder to access said lowest tray.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a section view of the invention.

FIG. 3 is a partial exploded view of a portion of the invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

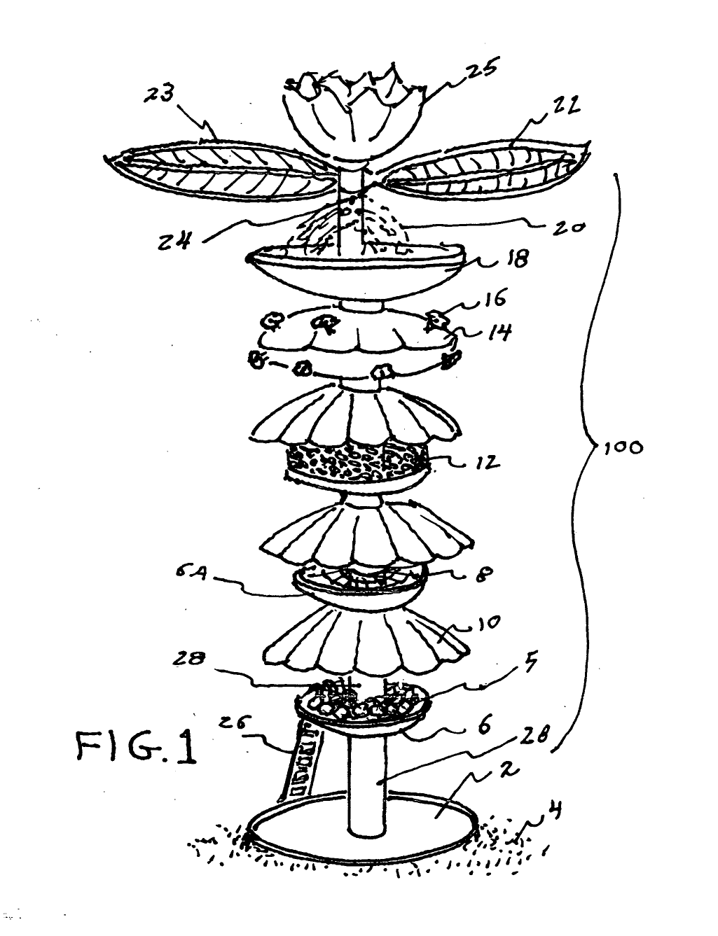

Referring now to FIG. 1 we see a perspective view of the wildlife feeder of the present invention 100. Feeding trays 6 are vertically stacked on a central tubular pole 28. Each feeding tray 6 is topped by a protective canopy member 10. Also stacked on pole 28 is a hummingbird feeder 14 having standard feeding orifices 16, and a bee habitat 12 and a birdbath 18. Reticulating water 20 is pumped from an internal electric pump and exits apertures 24 to replenish the birdbath 18. Photovoltaic leaf members 22, 23 recharge a DC battery power supply located within tubular pole 24 which in turn powers the internal water pump. Flower member 25 caps the entire assembly 100 and gives the assembly 100 a large plant-like appearance. A ladder 26 extends from the ground 4 to the first tray 6 to allow squirrels to feed on squirrel food 5 stored in the first tray 6. Alternately, the user may choose to fill first tray 6 with bird food, in which case the ladder 26 would be removed. Feeding tray 6A is topped by a screen member 8 which allows birds to have access to bird seed but not squirrels or other animals. A selection of screen members can be offered, each having a different mesh size. Smaller mesh size would be used if the user wanted small birds with small beaks to have access to bird seed 38. Larger mesh would be used if the feeding tray 6 was meant for larger birds having larger beaks.

The present invention can be adjusted by the user to include specific types of feeders or nesting habitats as he or she so desires. The unit may be set up for one species of bird or other animal such as bats, bees or squirrels. Or may be set up for any combination of animals. The present invention can consist of a single feeding tray and cover, or as many stacks of trays and covers that the user feels is satisfactory in meeting his or her outdoor wildlife needs.

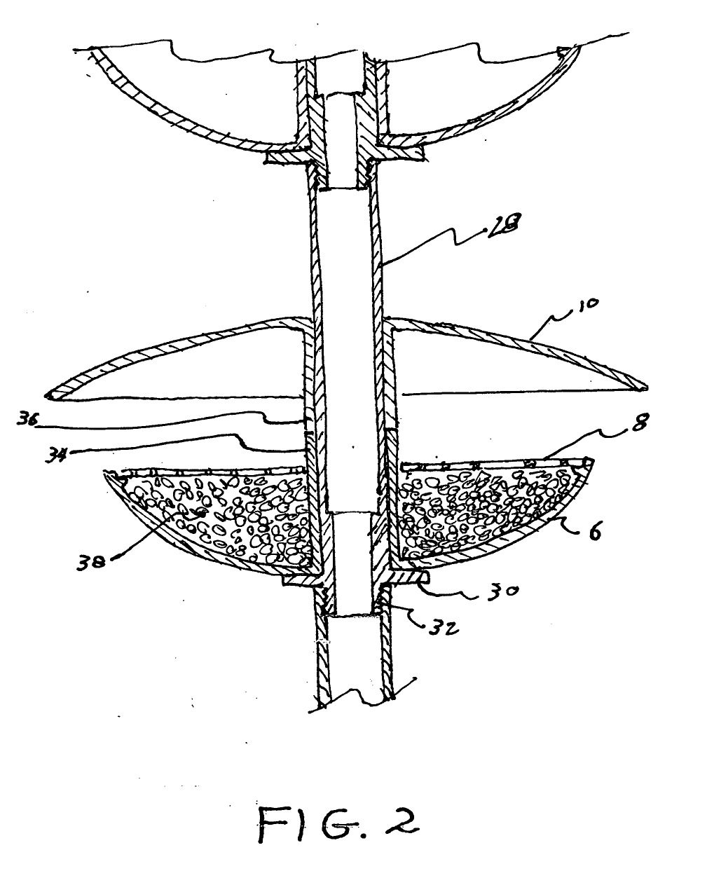

FIG. 2 is a partial section view of the invention 100. Central pole 28 is made of sections that screw together by mating threads 32. Each pole member 28 has a flange 30 that allows the feeder bowls 6 to be supported. Each feeder tray includes an upwardly directed central tube 34. Each canopy member 10 includes a downwardly directed tube 36 that mates with the top surface of tube 34 of feeder tray 6. In this way, the user can selectively stack feeder trays 6, and canopies 10 on pole sections 28 to build a custom wildlife feeding center. Bee habitat 12, humming bird feeder 18 and birdbath 18 also slide onto central pole 28 in a similar way as feeder trays 6. It should be noted that other standard methods of stacking and attaching the feeder bowls 6 and canopies 10 can be used and still fall within the spirit of the present patent application.

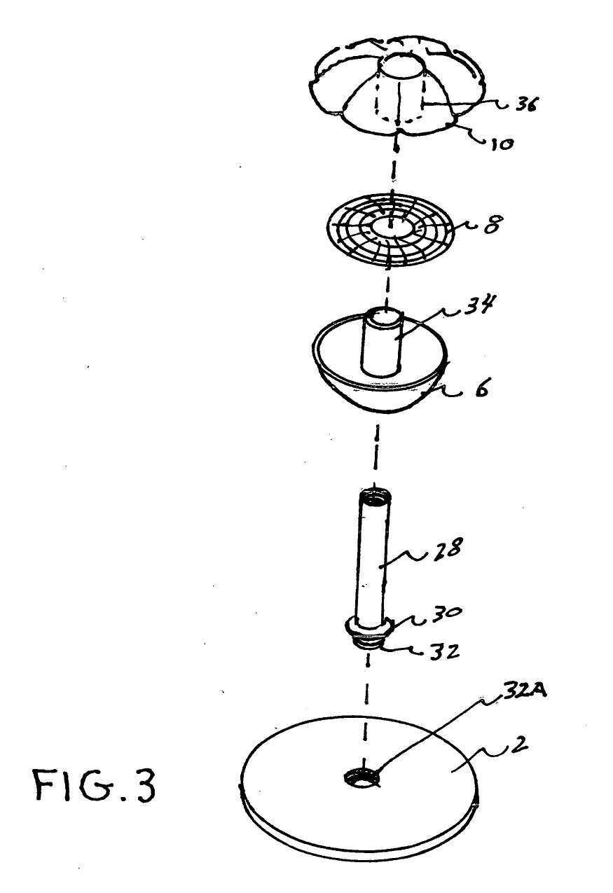

FIG. 3 is a partial exploded view of the invention 100. Pole section 28 can be screwed into base 2 via mating threads 32, 32A. Alternately, a spike can be fastened into the ground and pole section 28 can be screwed to the spike. Feeding bowl 6 can be slid down, via integral tube 34 over pole section 28 to rest on flange 30. Mesh screen 8 slides down on tube 34 and can be lifted when the user chooses to add bird seed to the feeding tray 6. Integral tube 36 shown in dotted line slides down over tube 28 until it reaches the top of feeding tube 34. In this way, the user can custom build a vertically oriented backyard feeding center for a variety of wildlife animals. The tooling cost for injection molds for all feeding trays and canopies is minimized because the feeders and canopies are identical in shape and therefore only require one tool for multiple feeders and one tool for multiple canopies.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. a backyard wildlife feeder comprising a plurality of vertically stacked tray members and canopy members;
said canopy members and said tray members alternating with each other forming a said vertically stacked feeding or habitat wildlife center.

2. A backyard wildlife feeder as claimed in claim 1 wherein said vertically stacked tray and canopy members include central apertures allowing them to be stacked on a central pole.

3. A backyard wildlife feeder as claimed in claim 2 wherein said central pole is fastened to a stable base member, allowing said pole and said trays and canopies to be supported in any desired backyard location.

4. A backyard wildlife feeder as claimed in claim 3 wherein one said tray member is a water feeding tray.

4. A backyard wildlife feeder as claimed in claim 4 further comprising a plurality of leaf shapes that each hold photovoltaic solar cells for powering a water pump located within said water tray.

5. A backyard wildlife feeder as claimed in claim 2 wherein vertical post sections plug into each other to form a single vertical post.

6. A backyard wildlife feeder as claimed in claim 2 further comprising a ladder leading from ground level to the first said tray, where squirrel food may be placed.

7. A backyard wildlife feeder as claimed in claim 2 wherein said trays and canopies can be repurposed to act as habitat locations for bees, birds, bats or other animals.

8. A backyard wildlife feeder as claimed in claim 2 wherein one said feeding tray includes small orifices to accommodate the feeding of humming birds;

9. A backyard wildlife feeder as claimed in claim 1 wherein said feeding trays are identical so that a single mold can manufacture a plurality of trays.

10. A backyard wildlife feeder as claimed in claim 1 wherein said canopy members are identical in size and shape so that a single mold can manufacture a plurality of canopy members.
